(19) United States
(12) Patent Application Publication
(10) Pub. No.: US 2021/0214874 A1
(43) Pub. Date: Jul. 15, 2021

(54) WASHING MACHINE WITH SELF-SELECTING WASHING CYCLE USING ARTIFICIAL INTELLIGENCE

(71) Applicant: Optimum Semiconductor Technologies Inc., Tarrytown, NY (US)

(72) Inventors: Sabin Daniel IANCU, Pleasantville, NY (US); John GLOSSNER, Nashua, NH (US); Beinan WANG, White Plains, NY (US)

(73) Assignee: Optimum Semiconductor Technologies Inc., Tarrytown, NY (US)

(21) Appl. No.: 17/272,809

(22) PCT Filed: Aug. 23, 2019
(86) PCT No.: PCT/US2019/047811

§ 371 Date: Mar. 2, 2021

Related U.S. Application Data
(60) Provisional application No. 62/727,036, filed on Sep. 5, 2018.

(51) Int. Cl. D06F 33/32; D06F 34/18

(52) U.S. Cl. CPC D06F 33/32; D06F 35/006; D06F 34/18

(57) ABSTRACT

A washing machine including a rotatable cylinder comprising a washing chamber to hold washables, one or more sensors, and a processing device, communicatively connected to the one or more sensors to control an operation of the washing machine, to receive sensor data captured by the one or more sensors, determine, using a machine learning model based on the sensor data, a plurality of properties associated with the washables, determine a setting for the washing machine based on the plurality of properties, and cause the washing machine to operate according to the setting.

### CROSS-REFERENCE TO RELATED APPLICATION

This application claims priority to U.S. Provisional Application 62/727,036 filed Sep. 5, 2018, the content of which is incorporated by reference in its entirety.

### TECHNICAL FIELD

The present disclosure relates to a washing machine, and in particular, to a washing machine capable of detecting the fabric properties and colors of a washable load and determining the washing cycle based on the detected fabric properties and colors.

### BACKGROUND

A washing machine may wash a certain quantity of fabric items (referred to as “washables”). The washables may include but not limited to clothes, linen, curtains, and table clothes. The washables can be made of different types of fabric materials such as, for example, wool, cotton, silk, nylon, polyester, or a combination thereof. Washables may be dyed with one or more colors such as, for example, white, red, blue, green, and black. In operation, a human operator may place a load of washables into the inner drum of the washing machine. The human operator may further select a washing cycle using a control panel of the washing machine, where the washing cycle may include settings for the water temperature, the washing time, the spinning strength, etc. The human operator may push a start button to start the operation of the washing machine.

The human operator selects the washing cycle based on his or her personal preference. The human operator, however, may not possess the requisite knowledge to select the optimal washing cycle that matches the current load of washables in the inner drum. This may lead to less than optimal washing results.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an intelligent washing machine according to an implementation of the disclosure.

FIG. 2 illustrates an installation of optical camera according to an implementation of the disclosure.

FIG. 3 illustrates an installation of optical camera and microwave sensor according to an implementation of the disclosure.

FIG. 4 illustrates a flowchart of a method to detect the stich size according to an implementation of the disclosure.

FIG. 5 shows neural networks for detecting properties of washables according to an implementation of the disclosure.

FIG. 6 illustrates a neural network for color detection according to an implementation of the disclosure.

FIG. 7 illustrates a flowchart of a method to detect the fabric properties and colors according to an implementation of the disclosure.

FIG. 8 illustrates a state chart according to an implementation of the disclosure.

FIG. 9 illustrate a reinforcement learning system according to an implementation of the disclosure.

FIG. 10 depicts a block diagram of a computer system operating in accordance with one or more aspects of the present disclosure.

### DETAILED DESCRIPTION

To overcome the identified and other deficiencies of washing machines, implementations of the present disclosure provide a technically-improved washing machine that is capable of detecting certain attributes of the washables prior to washing and is capable of determining an optimal washing cycle based on the determined attributes of the washables, thus improving the washing results without requiring the user to select the optimal washing cycle.

In particular, the washing machine as described in the disclosure may include sensors and a processing device. The sensors may include one or more optical cameras and one or more microwave sensors. The sensors may capture sensor data associated with the washables loaded into the inner drum of the washing machine. For example, an optical camera may capture images of the washables in the inner drum, and the microwave sensors may capture the depth and reflexivity measurements associated with the washables. Based on these captured sensor data, the processing device may execute one or more neural networks to determine the fabric properties and colors of the washables, and based on the determine fabric properties and colors of the washables, determine an optimal washing cycle for the load of washables. Thus, the washing machine may produce better wash results without requiring the human operator to know the relationship between washing cycles and fabrics. Further, the optimal washing cycle determined by implementations of the disclosure are not limited to the discrete selections available on the control panels of current washing machines. Implementations of the disclosure may allow settings beyond those available on the control panel, thus further improving the washing results beyond the capability of the current washing machines.

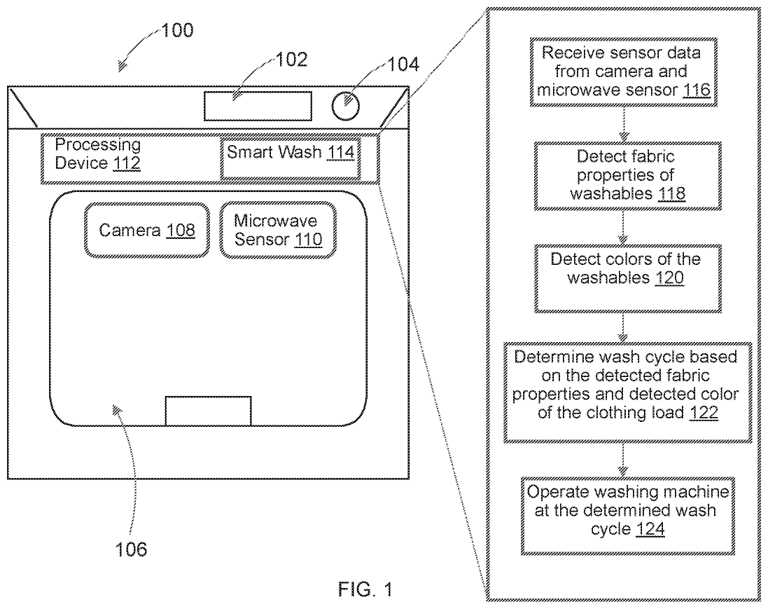

FIG. 1 illustrates an intelligent washing machine 100 according to an implementation of the present disclosure. Referring to FIG. 1, intelligent washing machine 100 may include a control panel 102, a start button 104, and an inner drum 106 that can be enclosed by a door (not shown). Control panel 102 may include select elements corresponding to different parameters that may be set by a human operator. The parameters may include washing time, water temperatures (hot, warm, cold), washing strengths (heavy, normal, light), and spin strengths measured in terms of the agitator rotations per minute (RPM) (high, medium, low, no spin). In some implementations, the human operator may select a combination of different parameters as the washing cycle and push the start button 104 to operate the washing machine based on the human operator's selection.

In an implementation of the disclosure, intelligent washing machine 100 may further include one or more sensors (e.g., an optical camera 108, a microwave sensor 110) and a processing device 112 that is communicatively coupled to the sensors. The sensors may include an optical camera 108 and microwave sensors 110. The optical camera 108 can be a video camera that may capture a sequence of time-coded image frames. Optical camera 108 can be a high-end camera, preferable with two magnification options including a wide-angle lens with focal distance of approximate 28 mm and f/1.8 aperture and a portrait lens with focal distance of approximate 56 mm and f/2.8 aperture.

Microwave sensor 110 can be a Doppler radar operating at the frequency around 24 GHz. In one implementation, the radar may include a transmission antenna (Tx antenna) and a receiving antenna (Rx antenna), where the Tx antenna and the Rx antenna can be microstrip phase arrays with a sweeping increment of 30 degrees.

While the one or more sensors are illustrated in FIG. 1 as installed onboard washing machine 100, in alternative implementations, any one of the one or more sensors can be provided offboard. For example, camera 108 can be an offboard video or image camera such as, for example, the cameras of a mobile device or a smart phone. Processing device 112 may be communicatively connected to the offboard camera through a communication link such as, for example, a communication network or a Bluetooth link. The human operator may aim the camera to the washables and capture video or images of the washables, and processing device 112 may receive the captured video or images of the washables through the communication link.

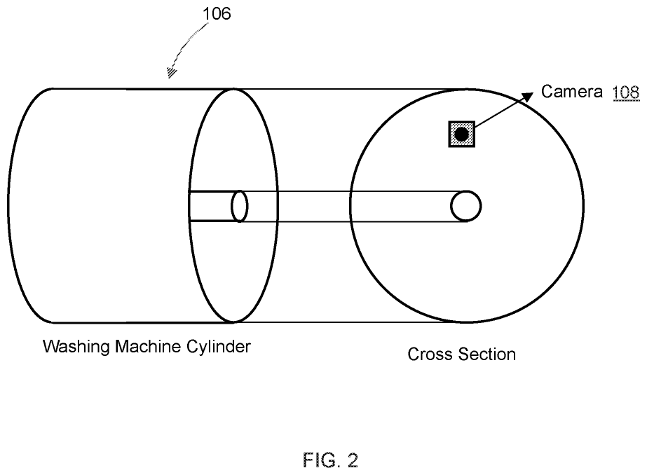

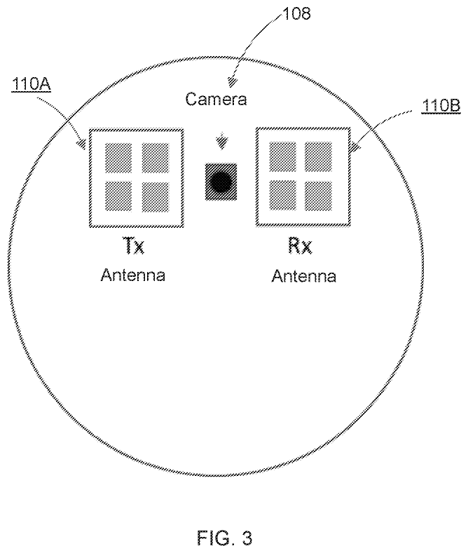

In one implementation, optical camera 108 and microwave sensor 110 may be installed inside the cylinder of inner drum 106. FIG. 2 illustrates an installation of optical camera 108 according to an implementation of the disclosure. As shown in FIG. 2, inner drum 106 of washing machine 100 may include a cylindrical chamber (“washing machine cylinder”) that may hold the load of washables. Optical camera 108 may be installed on the upper portion of the washing machine cylinder with the optical sensors facing inside the cylinder. Thus, optical camera 108 may capture images (or videos) of washables therein. In one implementation, microwave sensors 110 may be installed close to optical camera 108. FIG. 3 illustrates an installation of optical camera 108 and microwave sensor 110 according to an implementation of the disclosure. As shown in FIG. 3, microwave sensor 110 may include a Tx antenna 110A and a Rx antenna 110B, where optical camera 108 is situated in an area between Tx antenna 110A and Rx antenna 110B. Both Tx antenna 110A and Rx antenna 110B may be oriented toward a center inside the washing machine cylinder. Tx antenna 110A may emit microwaves that may be reflected off washables inside the washing machine cylinder. Rx antenna 110B may receive the reflected microwaves bounced off the washables. In one implementation, optical camera 108 and microwave sensors 110 are installed in such a way that their positions are fixed and are independent from the rotation of the inner drum of the washing machine. Thus, optical camera 108 and microwave sensors 110 may maintain the same positions and orientations while the drum of the cylinder rotates.

Referring to FIG. 1, processing device 112 can be a hardware processor such as a central processing unit (CPU), a graphic processing unit (GPU), or a neural network accelerator processing unit. Processing device 112 may be communicatively coupled to onboard or offboard optical sensor 108 and microwave sensors 110 to receive sensor data (e.g., image frames and microwave signals). In one implementation, washing machine 100 may include a storage device (e.g., a memory) (not shown) that may store the executable code of a smart wash program 114 that, when executed, may cause processing device 112 to perform the following operations.

At 116, responsive to loading washables into inner drum 106, processing device 112 may receive sensor data from optical camera 108 and/or microwave sensor 110. The sensor data can be images of the washables inside washing machine cylinder. Sensor data may also include microwave signals bounced off the washables. In one implementation, to capture all aspects of the washables, inner drum 106 may have several dry spins to allow optical camera 108 and microwave sensor 110 to record sensor data over a short period of time. The dry spins may allow items buried in the washables to come to top so that the sensors may capture sensor data of all items in the washables.

At 118, processing device 112 may detect the fabric properties of the washables based on the sensor data. The fabric properties may include types of fabrics (e.g., wool, cotton, silk, fleece, nylon, polyester, or mixtures thereof) and stitch patterns of the items.

At 120, processing device 112 may further detect colors of items in the washables based on the sensor data. The detected colors can be red, green, blue etc. Alternatively, the detected colors can be categories of dark color, medium color, and light color.

At 122, processing device 112 may determine the optical wash cycle based on the detected fabric properties and colors of items in the washables. The wash cycle may be represented by different setting parameters over the washing time. The setting parameters may include water temperatures, washing strengths, and spin speeds.

At 124, processing device 112 may cause the washing machine 100 operate according to the washing cycle determined by the setting parameters (referred to as a setting). Thus, washing machine 100 may be operated in an optimal mode based on the content of the washables, eliminating the need for human operator to select the settings.

Aspects of intelligent washing machine 100 and smart wash program 114 are described in the following.

In one implementation, a deep learning neural network may be used to determine the fabric properties and colors of items in the washables based on pixel values captured by optical camera 108. The deep learning neural network may be trained directly on pixel values of image frames captured by optical camera 108. This approach is commonly referred to as pixel exact segmentation neural network (referred to as the SegNet).

A neural network may include multiple layers of nodes including an input layer, an output layer, and hidden layers in-between. Each layer may include nodes associated with node values calculated from a prior layer through edges connecting nodes between the present layer and the prior layer. The calculations are propagated from the input layer through the middle hidden layers to the output layer. Edges may connect the nodes in a layer to nodes in an adjacent layer. Each edge may be associated with a weight value. Therefore, the node values associated with nodes of the present layer can be a weighed summation of the node values of the prior layer.

One type of the neural networks is the convolutional neural network (CNN) where the calculation performed at the hidden layers can be convolutions of node values associated with the prior layer and weight values associated with edges. For example, a processing device may apply convolution operations to the input layer and generate the node values for the first hidden layer connected to the input layer through edges, and apply convolution operations to the first hidden layer to generate node values for the second hidden layer, and so on until the calculation reaches the output layer. The processing device may apply a soft combination operation to the output data and generate a detection result. The detection result can be the fabric properties and colors of items in the washables.

In addition to the CNN, there are other types of neural network classifiers described in the literature, capable of detecting and classifying different objects in images or videos. In this case, an image of the washables in the washing machine cylinder may show a relatively large quantity of tangled fabric items, each item showing a little part of the whole in a completely random pattern. The pixel exact segmentation approach needs to detect each segment and associate it with a previously identified item. The complexity of pixel exact neural network approach is proportional to the factorial combinations generated by the segmentation process. Thus, combinations can be a very high value due to the huge variety of fabric item types. This makes it practically impossible to detect all the different types of cloths, given the large variety of models, patterns, materials, colors, using a SegNet type of neural network.

To reduce the computational complexity, implementations of the disclosure may detect fabric properties and colors in two separate stages, and then determine the appropriate washing cycle based on the detected fabric properties and colors.

In one implementation, each image frame captured may include an array of pixels, where the pixel array may be partitioned into N patches, each patch including M×M pixels, where N, M are positive integer values. The processing device may analyze each patch in two stages, the first stage to determine the fabric properties and the second stage to detect the colors for items captured within each patch. In another implementation, the processing device may analyze multiple patches in parallel for fabric properties and colors.

The fabric items in the washables may differ in terms of the size and pattern of the stitch, color, pattern and size of the thread, fabric materials (cotton, silk, wool, etc.). The size and pattern of the stitch of a fabric item represented in the image frame also depend on the distance between the camera's optical center and the item. The distance may vary depending on the quantity of the washables (i.e., the distance from the top of the load to the camera). Small loads will be on the bottom of the inner drum while an extra-large load may fill the drum up to the top. Therefore, in one implementation, the first step may include detect the depth map, where the depth map may include a two-dimensional array of values representing the distances from the optical center of optical camera 108 to the top layer of the load.

In one implementation, a neural network may be trained for depth detection. The ground truth for the training data set may be constructed using sparse ordinal annotations. Each training example only needs to be annotated with a pair of points and the relative distance of the training example to the camera. After training, the neural network may be used to detect the full depth map for other image frames captured by optical camera 108.

In another implementation, microwave sensor 110 may be used to detect the depth map. Microwave sensor 110 may include a 24 GHz Doppler radar including a Tx antenna 110A and a Rx antenna 110B placed next to the optical camera 108 as shown in FIG. 3. The Rx and Tx antennas may include microstrip phase array with a sweeping increment of 30 degrees. The round trip distance traveled by the microwave beam emitted from Tx antenna 110A received by Rx antenna 110B equals twice the distance between the antennas and the upper surface of the load.

The processing device may determine the fabric properties as follows. First, the dataset is grouped in classes with similar size of stitches. Each stich class may contain multiple subclasses of materials such as, for example, cotton, nylon etc.

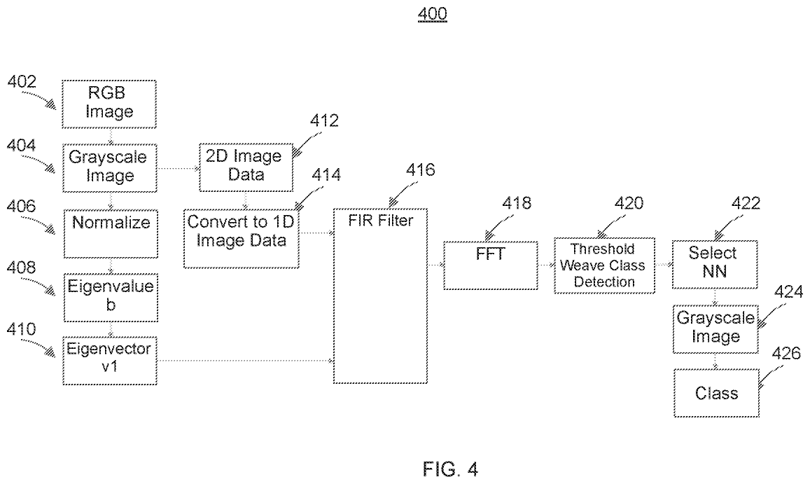

FIG. 4 illustrates a flowchart of a method 400 to detect the stich size according to an implementation of the disclosure. Method 400 may be performed by processing devices that may comprise hardware (e.g., circuitry, dedicated logic), computer readable instructions (e.g., run on a general purpose computer system or a dedicated machine), or a combination of both. Method 400 and each of its individual functions, routines, subroutines, or operations may be performed by one or more processors of the computer device executing the method. In certain implementations, method 400 may be performed by a single processing thread. Alternatively, method 400 may be performed by two or more processing threads, each thread executing one or more individual functions, routines, subroutines, or operations of the method.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be needed to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media. In one implementation, method 400 may be performed by a processing device 112 executing smart wash program 114 as shown in FIG. 1.

As shown in FIG. 4, at 402, processing device 112 may receive a patch of image frame. The patch may include an array (M×M) of pixel values. Each pixel value may include three components representing red, green, blue (RGB) components. At 404, processing device 112 may convert the RGB components to a greyscale value. For example, the greyscale value for each pixel may be calculated as a weighted average of its RGB components (e.g., greyscale=0.3*R+0.59*G+0.11*B). Further, at 406, processing device 112 may normalize the calculated greyscale value to a discrete value range (e.g., a range of [0, 255] represented by one byte). The M×M array of normalized greyscale values may form a square matrix. At 408, 410, processing device 112 may calculate the eigenvalues and eigenvectors of the M×M matrix. At 414, processing device 112 may convert the 2D image data 412 of each patch into a 1D vector. The 1D vector can be constructed by concatenating the 2D array row by row. At 416, processing device 112 may perform low-pass filter on the 1D vector, where the finite-impulse filter (FII) is formed using the eigenvectors. The lowpass FIR filter may remove the high frequency components in the 1D vector. The filtered signal reflects the periodicity of the stitches. At 418, processing device 112 may calculate a Fourier transform of the filtered signal. The Fourier transform of the filtered signal may return the frequency characteristic to that specific fabric stitch size. At 420, processing device 120 may further perform thresholding operations to determine the types or classes of the stitch.

Neural network may be used to determine the stich classes. For example, as shown in FIG. 4, at 422, processing device 112 may select a neural network, and at 424, use the neural network to determine the type or class of the stich at 426.

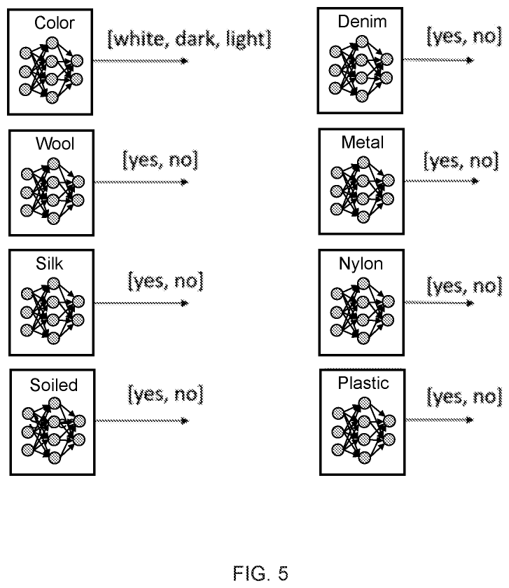

Each stitch class may include subclasses of different fabric materials. For example, with respect to a particular stitch size, the material can be cotton or wool. In one implementation, capsule neural networks may be used to determine the subclasses. A capsule neural network may add structures to the convolutional neural network. Each capsule may include a set of neurons that individually activate for different properties of a class. Each stitch class may be determined by a separate and discrete neural network as shown in FIG. 5, where the number of classes or the number of neural networks may vary. While CNN's are mostly translation invariant, capsule networks have the additional property of rotation invariance. This is useful in a spinning drum environment. The capsule networks commonly do not count how many of a specific type of fabric is present. For the washer application, the network only needs to know the existence of a specific fabric in the washables and not the number of times that fabric is present. For example, FIG. 5 shows there may be ten capsule neural networks to determine washable colors (white, dark, light), wool (yes or no), silk (yes or no), soiled (yes or no), denim (yes or no), metal (yes or no), nylon (yes or no), and plastic (yes or no).

In one implementation, the colors of the fabric items in the washables may be determined using a pixel binning method. The method may include assigning a number of bins in the color histogram, each bin corresponding to a number of colors. For each pixel in a patch of the captured image frame, processing device 112 may calculate the Euclidean distances from the pixel color to each of the bin colors. Processing device 112 may further increase the counter of the nearest color on the histogram. Finally, processing device 112 may apply a threshold to the histogram to eliminate false detections.

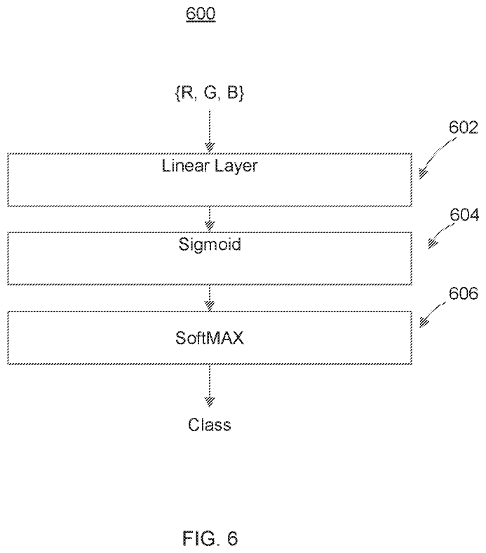

In another implementation, neural network may be used to determine the colors. Compared to the pixel binning method, the neural network approach may consume less computation resources. FIG. 6 illustrates a neural network 600 for color detection according to an implementation of the disclosure. As shown in FIG. 6, neural network 600 may include two layers, one linear layer 602 including 25 neurons with Sigmoid actuator 604 and one SoftMax layer 606. The 25 neurons may correspond to a 25 classes of colors. For every patch, the input to network 600 is a vector of size 3 representing the average of the RGB values (<R>, <G>, <B>), and the output is the color classes. In one implementation, the neural network to detect colors is separate from the neural networks used to detect fabric types.

The neural network for material detection may be trained and tested using the Fabrics Dataset (https://ibug.doc.ic.ac.uk/resources/fabrics/). The Fabric Dataset includes approximately 2,000 samples of 26 different types of fabrics. Six or eight of most common types are selected for training and testing.

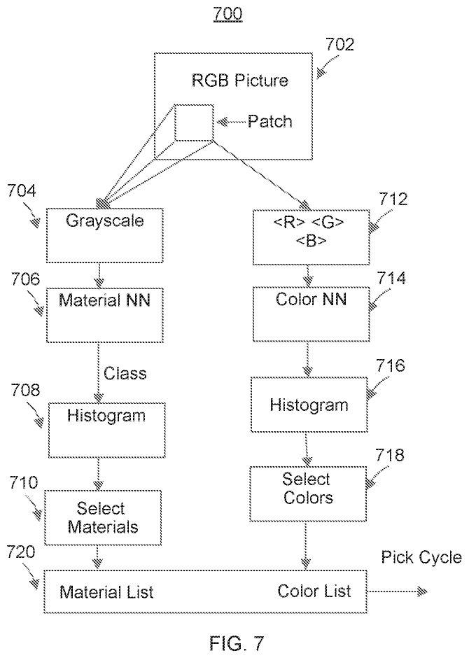

In one implementation, the intelligent washing machine may first perform a slow dry spin including a determined number of cycles to allow sensors capture sensor data, and detect, based on the sensor data, the fabric properties and colors. FIG. 7 illustrates a flowchart of a method 700 to detect the fabric properties and colors according to an implementation of the disclosure. As shown in FIG. 7, at 702, processing device 702 may identify a patch from an RGB image frame. At 704, processing device 112 may convert the RGB values to greyscale values with normalization. At 706, processing device 112 may apply a material neural network to the greyscale image to determine material classes. As discussed above, the resulting classes can be multiple classes associated with likelihood probabilities. Also, multiple patches may generate multiple candidate material classes. At 708, processing device 112 may calculate a histogram of detected material classes. The histogram may reflect the frequencies of the detection of different material classes. At 710, processing device 112 may select the material classes based on the histogram of material classes. The materials selected are those with higher probabilities.

Similarly, at 712, processing device 112 may calculate the RGB values of a patch of the image frame. At 714, processing device 112 may apply a color neural network to determine the color classes in the patch. At 716, processing device 112 may calculate a histogram of detected color classes. The histogram may reflect the frequencies of the detection of different color classes. At 718, processing device may select the color classes based on the histogram of color classes. The colors selected are those with higher probabilities. At 720, processing device 112 may form a material list of detected materials and a color list of detected colors of fabric items.

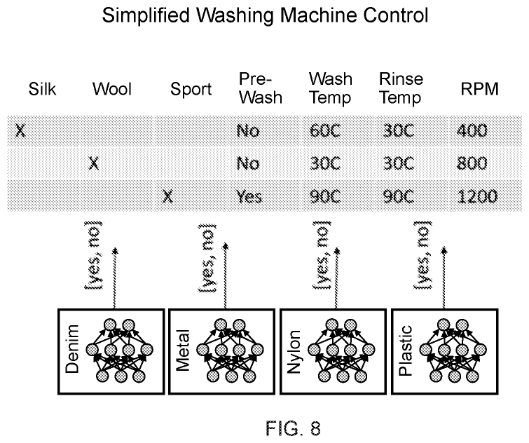

In one implementation, a state chart may be used to map the detected materials and colors to a washing cycle. FIG. 8 illustrates a state chart according to an implementation of the disclosure. As shown in FIG. 8, the state chart includes a matching table that maps fabric types and colors to a proper washing cycle including pre-wash, wash temperature, rinse temperature, and rotations per minutes representing the washing strength. In an alternative implementation, instead of using the state chart, processing device 112 may directly map the determined material and/or color of the washables to proper levels of pre-wash time, wash temperature, rinse temperature, and rotations per minutes. These levels may vary, based on the determined material and/or color of the washables,

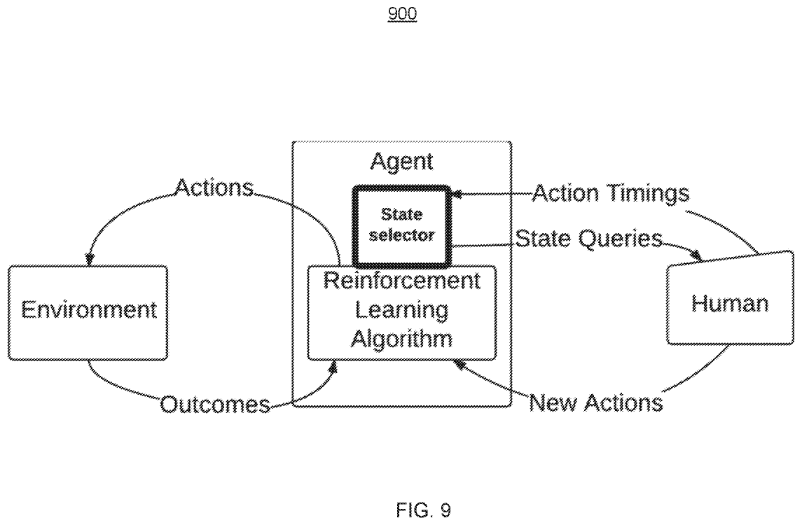

It should be recognized that not all users want to choose the optimal washing cycle even when the processor classifies the washables with 100% accuracy. To accommodate user preferences a special type of machine learning algorithm referred to as a reinforcement learning algorithm can be used to match the user's preferences. In one implementation, the following scenario is possible: the user has the option to personalize the machine by training the neural networks to recognize certain personal items and to pick the appropriate cycle. This may be done by introducing a reinforcement learning system 900 as shown in FIG. 9. System 900 may determine the characteristics (e.g. fabric types, colors, etc.) and set the washing cycle based on the state chart as described in conjunction with FIG. 8. If the human operator overrides and changes the washing machine cycle, the processing device of the system may execute a reinforcement learning algorithm to learn the preference of the user and choose the user-preferred cycle in subsequent laundry loads. The information is communicated back to a server and used to train the environment. The algorithm can also be used to learn user-specific cases including important personal items. The following process can be used:
a. The user may have a number of sensitive items that she or he does not want to mix with other items. Otherwise, the machine will pick a cycle to protect those particular items;
b. Take a picture of each item (using the washing machine camera) and annotate the picture with the type of fabric;
c. Save all pictures and send the annotated pictures to a server;
d. The server may retrain the neural network with the new items and train a new neural network.
e. In the future, the washing machine will pick a default cycle or a preprogramed personal cycle based on the new information, Since the personal items are part of the training, the detection rate will be much improved.

Since the new network makes decisions based on images representing appearance and many fabrics look very similar despite of different compositions, some different tests may help discriminate between different types of fabric. A good candidate would be the high frequency reflectivity method.

The microwave sensor 110 may be used to determine the fabric properties. The properties of reflection and transmission of microwaves at the fabric surface may be used to separate two materials. Also, these properties depend on the electric permittivity which in turn depend on the water content.

Different fabrics may store different amounts of moisture depending on the density of the stiches and the adhesive properties of the specific materials. As a consequence, the reflection coefficients for dry and wet fabrics will be different.

Dry fabrics will reflect microwaves differently than moist fabrics. Using the Maxwell Garnett formula, the effective permittivity is done by the following formula:

$${ϵ}_{eff} = \frac{2 ϵ f ( {ϵ}_{w} - ϵ ) + 2 {ϵ}_{w} + ϵ}{2 {ϵ}_{w} + ϵ - f ( {ϵ}_{w} - ϵ )}$$

Where: ϵ_{w} is the permittivity of the water, ϵ is the permittivity of the fabric and f is the fraction of water stored in the fabric.

The reflective index is:

$$R = {\vert \frac{{n}_{eff} - {n}_{air}}{{n}_{eff} + {n}_{air}} \vert}^{2}$$

Where n is the square root of the permittivity.

The following operations may be used to determine fabric materials based on permittivity and reflective index. Processing device may be configured to perform the following:
1. The processing device may initially calibrate the system as follows:
   The reflective index R is measured for different moist fractions f, where R changes significantly with f. The values of R can be stored in a lookup table in a storage device connected to the processing device.
2. The processing device may correct the received (reflected) wave energy for the distance between the antenna and the surface of the load (the EM energy is attenuated with the square of the distance) and average out over time intervals. The distance is measured using the phase delay between the incident and reflected wave.
3. The processing device may pair each camera measurement with a microwave measurement. The ambiguity between two different materials like cotton and polyester that may arise during the detection using the camera only may be resolved by reflectivity difference and as a result the difference between the received microwave energy.
4. If the washing machine is equipped with the microwave sensor, the dry and wet mode testing may be replaced with only wet (moist) test. Although, the moisture level may be controlled through some mist process.
5. One more complex neural net including both camera and microwave sensors can be trained to take into consideration both the images captured by the camera and the reflective index R measured by the microwave sensor.

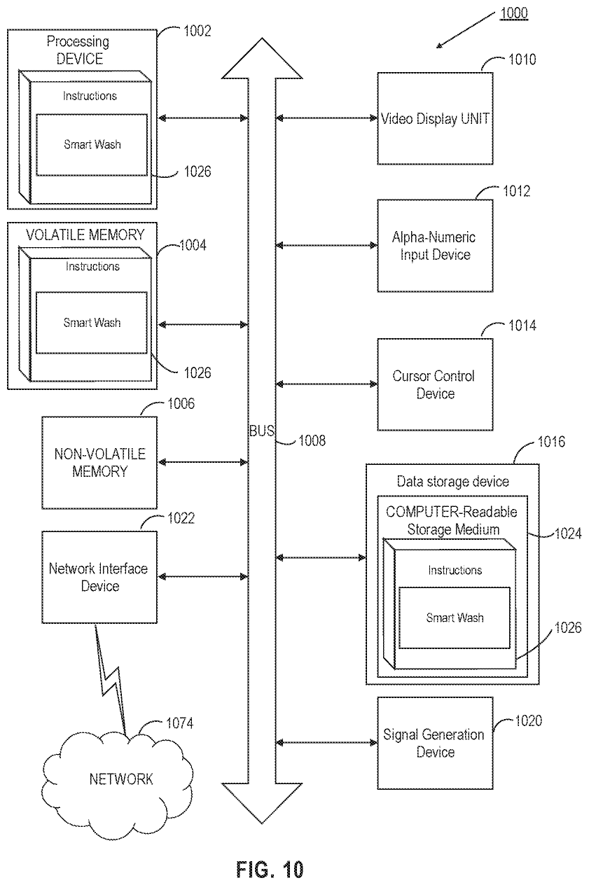

FIG. 10 depicts a block diagram of a computer system operating in accordance with one or more aspects of the present disclosure. In various illustrative examples, computer system 1000 may correspond to the processing device 112 of FIG. 1.

In certain implementations, computer system 1000 may be connected (e.g., via a network, such as a Local Area Network (LAN), an intranet, an extranet, or the Internet) to other computer systems. Computer system 1000 may operate in the capacity of a server or a client computer in a client-server environment, or as a peer computer in a peer-to-peer or distributed network environment. Computer system 1000 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 1000 may include a processing device 1002, a volatile memory 1004 (e.g., random access memory (RAM)), a non-volatile memory 1006 (e.g., read-only memory (ROM) or electrically-erasable programmable ROM (EEPROM)), and a data storage device 1016, which may communicate with each other via a bus 1008.

Processing device 1002 may be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 1000 may further include a network interface device 1022. Computer system 1000 also may include a video display unit 1010 (e.g., an LCD), an alphanumeric input device 1012 (e.g., a keyboard), a cursor control device 1014 (e.g., a mouse), and a signal generation device 1020.

Data storage device 1016 may include a non-transitory computer-readable storage medium 1024 on which may store instructions 1026 encoding any one or more of the methods or functions described herein, including instructions of the constructor of smart wash program 114 of FIG. 1 for implementing method 400.

Instructions 1026 may also reside, completely or partially, within volatile memory 1004 and/or within processing device 1002 during execution thereof by computer system 1000, hence, volatile memory 1004 and processing device 1002 may also constitute machine-readable storage media.

While computer-readable storage medium 1024 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “receiving,” “associating,” “determining,” “updating” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may comprise a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform method 300 and/or each of its individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

What is claimed is:

1. A washing machine, comprising:
a rotatable cylinder comprising a washing chamber to hold washables;
one or more sensors; and
a processing device, communicatively connected to the one or more sensors to control an operation of the washing machine, to:
receive sensor data captured by the one or more sensors;
determine, using a machine learning model based on the sensor data, a plurality of properties associated with the washables;
determine a setting for the washing machine based on the plurality of properties; and
cause the washing machine to operate according to the setting.

2. The washing machine of claim 1, wherein the one or more sensors comprise at least one of a camera for capturing one or more images of the washables or a microwave sensor for emitting a first microwave signal to the washables and receiving a second microwave signal reflected from the washables.

3. The washing machine of claim 2, wherein the camera is installed within the washing chamber, and the camera comprises a lens directed at a center of the chamber, and wherein the camera is fixed to a position that is independent from a rotational movement of the rotatable cylinder.

4. The washing machine of claim 2, wherein prior to receiving the sensor data captured by the one or more sensors, the processing device is to cause the rotatable cylinder to rotate a pre-determined number of rotations and capture the one or more images of the washables while the rotatable cylinder rotates.

5. The washing machine of claim 2, wherein to determine, using a machine learning model based on the sensor data, a plurality of properties associated with the washables, the processing device is to:
receive the one or more images comprising an image frame, the image frame comprising an array of pixel values;
convert the array of pixel values into a vector comprising greyscale elements;
low-pass filter the vector comprising greyscale elements to generate a filtered vector comprising greyscale elements;
calculate a frequency-domain representation of the filtered vector comprising greyscale elements; and
determine, using the machine learning model based on the frequency-domain representation of the filtered vector comprising greyscale elements, the plurality of properties associated with the washables.

6. The washing machine of claim 2, wherein the microwave sensor comprises a microwave emitter and a microwave receiver, wherein the camera is situated between the microwave emitter and the microwave receiver, and wherein the processing device is to:
determine a distance between the washables and a center of the camera based on a time delay between the first microwave signal emitted from the microwave emitter and the second microwave signal received by the microwave receiver; and
determine, using the machine learning model based on the one or more images and the distance, the plurality of properties associated with the washables.

7. The washing machine of claim 2, wherein the microwave sensor comprises a microwave emitter and a microwave receiver, and wherein the processing device is to:
determine a reflective index associated with the washables;
determine a moist fraction value associated with the washables based on the reflective index; and
determine, using the machine learning model based on the one or more images and the moist fraction, the plurality of properties associated with the washables.

8. The washing machine of claim 2, wherein to determine, using a machine learning model based on the sensor data, a plurality of properties associated with the washables, the processing device is to:
partition an image frame of the one or more images into a plurality of patches;
for each of the plurality of patches,
determine, using a first machine learning model, color classes of the washables;
convert colored pixel values in the patch into a vector comprising greyscale elements;
determine, using a second machine learning model based on the vector comprising greyscale elements, one or more material classes of the washables; and
determine the setting for the washing machine based on the determined color classes and material classes for all of the plurality of patches.

9. The washing machine of claim 1, wherein the setting comprises at least one of a level of pre-wash, a level of wash temperature, a level of rinse temperature, or a rotations per minute for the rotatable cylinder.

10. The washing machine of claim 1, wherein the plurality of properties comprises at least one of a type of fabric of the washables, a color of the washables, a type of material of the washables, or a wear condition of the washables.

11. The washing machine of claim 1, wherein the machine learning model comprises at least one of a convolutional neural network (CNN), a fully-connected neural network, a pixel exact segmentation neural network (SegNet), a capsule neural network, or a reinforcement learning neural network.

12. The washing machine of claim 11, wherein responsive to identifying a user override of the setting, the processing device is to update the machine learning model based on the user override.

13. A method to operate a washing machine, comprising:
receiving, by a processing device of the washing machine, sensor data captured by one or more sensors communicatively coupled to the processing device;
determining, by the processing device using a machine learning model based on the sensor data, a plurality of properties associated with the washables;
determining, by the processing device, a setting for the washing machine based on the plurality of properties; and
causing the washing machine to operate according to the setting.

14. The method of claim 13, wherein the one or more sensors comprise at least one of a camera for capturing one or more images of the washables or a microwave sensor for emitting a first microwave signal to the washables and receiving a second microwave signal reflected from the washables.

15. The method claim 14, wherein the camera is installed within the washing chamber, and the camera comprises a lens directed at a center of the chamber, and wherein the camera is fixed to a position that is independent from a rotational movement of the rotatable cylinder.

16. The method of claim 14, further comprising:
prior to receiving the sensor data captured by the one or more sensors, causing the rotatable cylinder to rotate a pre-determined number of rotations and capture the one or more images of the washables while the rotatable cylinder rotates.

17. The method of claim 14, determining, using a machine learning model based on the sensor data, a plurality of properties associated with the washables further comprising:
receiving the one or more images comprising an image frame, the image frame comprising an array of pixel values;
converting the array of pixel values into a vector comprising greyscale elements;
low-passing filter the vector of greyscale elements to generate a filtered vector comprising greyscale elements;
calculating a frequency-domain representation of the filtered vector comprising greyscale elements; and
determining, using the machine learning model based on the frequency-domain representation of the filtered vector comprising greyscale elements, the plurality of properties associated with the washables.

18. The method of claim 14, wherein the microwave sensor comprises a microwave emitter and a microwave receiver, and wherein the camera is situated between the microwave emitter and the microwave receiver, the method further comprising:
determining a distance between the washables and a center of the camera based on a time delay between the first microwave signal emitted from the microwave emitter and the second microwave signal received by the microwave receiver; and
determining, using the machine learning model based on the one or more images and the distance, the plurality of properties associated with the washables.

19. A machine-readable non-transitory medium having stored thereon machine-executable instructions that, when executed, cause a processing device to operate a washing machine, the processing device is to:
receive, by the processing device of the washing machine, sensor data captured by one or more sensors communicatively coupled to the processing device;
determine, by the processing device using a machine learning model based on the sensor data, a plurality of properties associated with the washables;
determine, by the processing device, a setting for the washing machine based on the plurality of properties; and
cause the washing machine to operate according to the setting.

20. The machine-readable non-transitory medium of claim 19, wherein the one or more sensors comprise at least one of a camera for capturing one or more images of the washables or a microwave sensor for emitting a first microwave signal to the washables and receiving a second microwave signal reflected from the washables.
